(19) United States
(12) Patent Application Publication
(10) Pub. No.: US 2012/0072425 A1
(43) Pub. Date: Mar. 22, 2012

(54) CUSTOMER FOCUSED KEYWORD SEARCH IN AN ENTERPRISE

(75) Inventors: Rahim Yaseen, Redwood City, CA (US); Manish Gupta, Gachibowli (IN); Ou-Dan Peng, Mountain View, CA (US); Christian Thompson, Redwood City, CA (US); Matthew David Kettle, Palo Alto, CA (US)

(73) Assignee: Oracle International Corporation, Redwood Shores, CA (US)

(21) Appl. No.: 13/033,820

(22) Filed: Feb. 24, 2011

Related U.S. Application Data
(60) Provisional application No. 61/384,082, filed on Sep. 17, 2010.

(51) Int. Cl. G06F 17/30

(52) U.S. Cl. 707/741; 707/769; 707/E17.014; 707/E17.002

(57) ABSTRACT

A method, system, and computer readable storage medium are provided for performing a centralized search to locate information having a common context in an enterprise. Such search can be provided by defining a logical object that groups customer profile and related objects such as contacts, leads, opportunities, notes, interactions, and the like for a search in a customer context. A customer identifier can serve as a key to link the related objects. A keyword search of a logical group is also provided that allows for a single unified search across customers and related objects, or to search within a single customer and related objects. One aspect of the logical group keyword search provides for refining the search to show a subset of objects and to use filtering of object attributes. Search results indicate the customer context by highlighting the customer name in the result.

### FIELD OF THE INVENTION

The present invention relates to keyword searching in an enterprise environment, and, more particularly, to implementing a single unified search on data stored in multiple sources that provides an intuitive and contextual way of finding related information.

### BACKGROUND OF THE INVENTION

Business entities can store significant quantities of data across the enterprise. One type of data of particular interest is that associated with customers and their interaction with the business entity. Customer-related information can include, for example, customer profile data, customer contact information, sales leads, sales opportunities, customer notes, and other types of interactions with customers. This information can be stored in a variety of applications and databases throughout the enterprise.

Enterprise-level applications make use of and add to the stored customer-related data. For example, customer relationship management (CRM) applications utilize and store information relating to interactions with customers of the enterprise. Such interactions include marketing, sales, orders, support, and service. This data can be stored in a variety of locations and have a variety of formats, as dictated by the nature of the stored information. Finding data relevant to a specific task and making use of that data can be complicated by the quantity, varied locations, and lack of cohesive organization of the data.

It is therefore desirable to have a customer-centric view of data that provides consistent organization from data source-to-data source and supplies the relationships of that data to the customer. In order to avoid learning and manipulating multiple user interfaces and navigational means associated with each data source, it is further desirable to have a single unified search tool that provides users with a consistent mechanism for finding and accessing the customer information.

### SUMMARY OF THE INVENTION

A method, system and computer-readable medium are provided for performing a centralized search to locate information having a common context in an enterprise.

One embodiment of the present invention provides a mechanism for searching through records associated with one or more enterprise data sources for records containing one or more selected words and displaying a least a portion of each record containing the one or more selected words. Each record has an associated contextual identifier, which is also displayed. The records can be stored in one or more search indexes.

One aspect of the above embodiment provides a mechanism for limiting the set of records to those records associated with a specified contextual identifier, and displaying information related to that specified contextual identifier. A further aspect provides a mechanism for displaying a listing of data sources associated with the records containing the one or more selected words. That listing of data sources is a subset of the one or more enterprise data sources. A still further aspect provides a mechanism for selecting a data source from the listing of data sources associated with the records and limiting the displaying to those records associated with the selected data source and associated with the specified contextual identifier.

Another aspect of the above embodiment provides that each record includes an identifier of the enterprise data source associated with the record, an identifier of the record itself, and a portion (or snippet) of the record that includes the one or more selected words and a predetermined number of words preceding and succeeding the one or more selected words. A further aspect provides for displaying a link to the enterprise data source identified by the displayed portion of the record.

Still another aspect of the above embodiment provides a mechanism for generating a search index comprising the set of records associated with the one or more data sources, and performing the searching using that search index. A further aspect provides for generating the search index by storing a record in the search index that includes information from the enterprise data source for the record, a pointer to the location of the original data, and the associated contextual identifier.

The foregoing is a summary and thus contains, by necessity, simplifications, generalizations and omissions of detail. Consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features and advantages made apparent to those skilled in the art by referencing the accompanying drawings.

FIG. 1 is a simplified block diagram illustrating the concept of a customer-centric data relationship, such as that found in a CRM environment

FIG. 2 is a simplified block diagram illustrating a set of customer-related data source groupings.

FIG. 3 is a simplified block diagram illustrating a logical data model of the customer-centric hub-and-spoke concept, usable by embodiments of the present invention.

FIG. 4A illustrates an example of a search interface provided by embodiments of the present invention.

FIG. 4B illustrates a customer-focused search interface usable by embodiments of the present invention.

FIG. 4C illustrates an example of an advanced search display usable by embodiments of the present invention.

FIG. 5A illustrates an example of a search results pane provided by a search across customers for a set of keywords, as provided by embodiments of the present invention.

FIG. 5B illustrates an example of a search results pane displaying a “drill down” from a search result to the information from the resulting object itself.

FIG. 6 is a simplified flow diagram illustrating an example of a search procedure executed by embodiments of the present invention.

FIG. 7 is a simplified flow diagram illustrating a process for displaying records matching keywords from a search, in accord with embodiments of the present invention.

FIG. 8 is a simplified block diagram illustrating one example of an enterprise data environment compatible with embodiments of the present invention.

FIG. 9 is a simplified block diagram illustrating an enterprise server architecture usable in conjunction with embodiments of the present invention.

FIG. 10 is a simplified block diagram of a computer system suitable for implementing aspects of the present invention.

FIG. 11 is a simplified block diagram of a computer network suitable for implementing aspects of the present invention.

### DETAILED DESCRIPTION

Embodiments of the present invention provide a method, apparatus and system for performing a centralized search to locate information having a common context in an enterprise. One embodiment of the invention provides such search by defining a logical object that groups customer profile and related objects such as contacts, leads, opportunities, notes, interactions, and the like for a search in a customer context. One aspect of the above embodiment uses a customer identifier as a key to link the objects. Another embodiment of the invention provides a keyword search of a logical group that allows for a single unified search across customers and related objects, or to search within a single customer and related objects. One aspect of this embodiment provides for refining the search to show a subset of objects and to use filtering of object attributes. A further embodiment of the invention provides for a search result format and navigation pattern that gives a user a straightforward and consistent way of finding the contextually-related information that is the result of the search.

On a daily basis, a business entity can collect, store and disseminate large quantities of information pertinent to the operations of that business entity. Utility applications performing this collecting, storing and disseminating vary according to the nature of the information (e.g., information related to customers, products, finances, and human resources), the sources from which the information is collected, and the locations in which the information is stored. Certain information, such as information related to customers, can be stored in a manner that associates the individual data records with a contextual group (e.g., a specific customer identifier). But, typically, the information is stored in such a manner that the data records are associated with the particular utility used to enter that data or the particular group that entered that data, and therefore is not available to be associated with a contextual grouping across the enterprise.

Contextual Data Environment

Customer relationship management (CRM) is one area in which disparate sources and formats of data can affect an enterprise user's ability to get complete information about a customer. Effective CRM relies upon an ability to gather information about a customer, including, for example, contacts, orders, support information, service information, meetings, and the like. Embodiments of the present invention allow for gathering of information stored in one or more locations from a variety of originating services to be displayed in a customer-centric context.

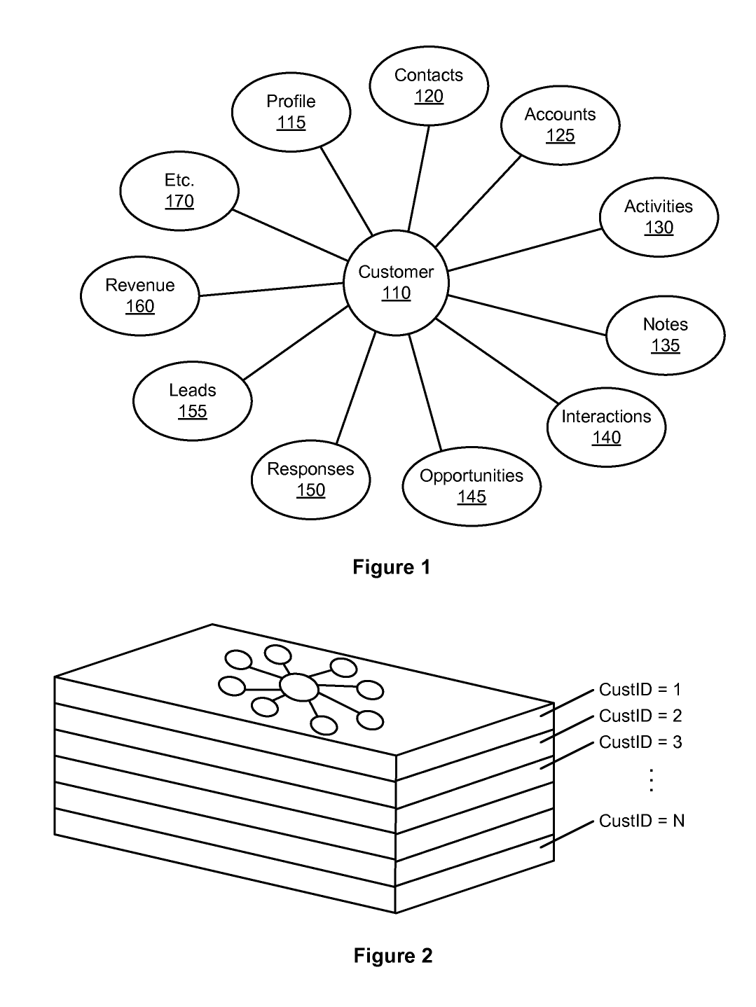

FIG. 1 is a simplified block diagram illustrating the concept of a customer-centric data relationship, such as that found in a CRM environment. FIG. 1 illustrates the relationship of data sources to the customer as an analog to a hub with spokes. At the hub of the environment is a customer 110. A series of spokes connect the customer hub to various sources of customer-related data. Customer-related data, for example, includes customer profile information 115, customer contact information 120, customer account information 125, customer-related activities 130, notes related to customer interaction 135, information related to customer interactions 140, sales opportunity information 145, customer response information to contact 150, sales lead information 155, customer-related revenue 160, and other additional information 170. Each data source can have multiple records stored therein related to a specific customer. The data sources can be stored in one or more tables of a single database or multiple databases, and by utilities provided by a single party or provided by multiple parties. A common feature between each of these data sources is a way to associate each record with a customer (e.g., a customer identifier). Information in each of the various data sources may be provided by different divisions of the enterprise (e.g., sales, marketing, service, and support).

FIG. 2 is a simplified block diagram illustrating a set of customer-related data source groupings. The hub-and-spoke illustration of FIG. 1 can be thought of as a relationship between various data source records and a single customer. All the customers of a business entity can be considered to have their own set of records in various spokes connected to a customer-associated hub, as shown in FIG. 2. Each customer need not have records in each data source spoke. But data in each data source is associated with a particular customer through a unique customer identifier. In cases where a customer identifier in a data source is not the same as that for other data sources (e.g., a foreign data source), a mapping can be provided to associate the customer identifier of that data source with a customer identifier associated with the other data sources. One example of such a foreign data source is a web-based forum in which customers may be referred to by their common name, and a mapping is provided between customer common name and customer identifier. Using such a customer-centric hub-and-spoke model of enterprise data can improve usability and understandability of that data.

Context-Based Logical Data Model

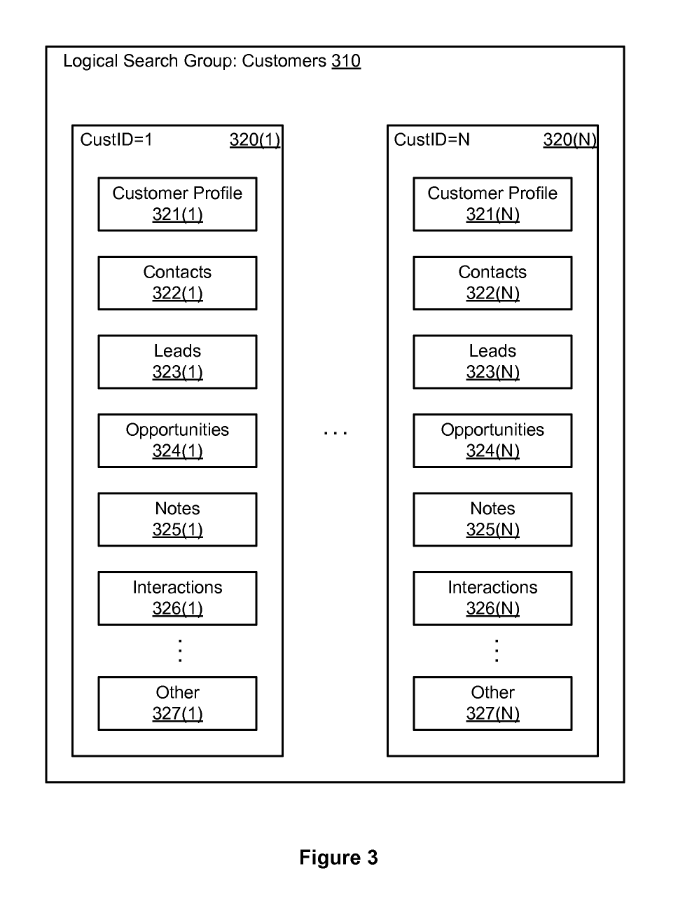

FIG. 3 is a simplified block diagram illustrating a logical data model of the customer-centric hub-and-spoke concept, usable by embodiments of the present invention. As discussed above, certain applications, such as CRM applications, can benefit from a context-based view of data. For example, in a CRM application, the customer is a fundamental context for data. Customer-related data is associated in a logical customer group 310. Each customer of the enterprise has a customer object 320(1)-(N). As illustrated, customer object 320(1) is associated with a customer identifier “1” and customer object 320(N) is associated with a customer identifier “N.” Each customer object can be a grouping of customer and related objects gathered from various data sources. As shown in the example illustration, customer-related objects can include a customer profile object 321, a contacts object 322, a leads object 323, an opportunities object 324, a notes object 325, an interactions object 326, and other customer-related objects 327. Searches can be performed on these grouped objects.

Search engines typically use one or more search indexes in order to facilitate quick location of data objects that match search criteria. Using a search index, a large number of data objects can be queried for specified words within milliseconds, whereas a sequential scan of every word in the various data objects in the various databases could take hours, especially if the data objects are large.

Search indexes vary in architecture to meet various design factors such as the amount of memory needed to store the index, how to store the index data, and the like. In general, search indexes contain entries, each of which maps a keyword to one or more identifiers of data objects that contain one or more instances of the keyword. Search indexes may include additional information such as the frequency of each keyword in the data object or the position of the keyword in the data object.

It is anticipated that the information associated with the various customer objects 320(1)-(N) will be found in one or more search indexes, which are built from original data sources located within or accessible to the enterprise. As noted above, each data source will have some mechanism for identifying records with a customer identifier to enable the associations illustrated in FIG. 3. The customer identifier will also be included in the search index records for ease of association with an appropriate customer-context during search.

Each object illustrated in FIG. 3 (e.g., 320, 321, 322) is a business object having an associated view object that shapes the data object for consumption by the search indexer. A view object defines those attributes interesting to a search, such as a primary key, natural key, text column descriptions, comments or names of related objects, and the like. A view object can also include transient attributes associated with applying security rules or result filtering features. For example, a view object display attribute provides a listing of those attributes available for a search results display. Display attributes can be selected based on user needs, such as those record attributes users most want to see or record attributes that users need for decision making. Another example of a view object attribute are searchable attributes. Searchable attributes are important to a business object, for example, a customer name, account number, revenue amounts, and the like. Searchable attributes are typically text rich attributes such as comments and descriptions. A view object associated with a data object can also include various filter attributes such as key fields (e.g., customer name or primary contact) which are likely to be searched on.

Table 1 provides an example definition of a view object for a customer account. The table illustrates the various definable attributes for a searchable view object, including, for example, control fields, security attributes, display attributes, searchable attributes, and additional filter attributes.

TABLE 1
View Object

| | |
|---|---|
| Business Object Name | Customer Account |
| Description | Info such as Account number, comments, status, tax code for Active Customer Accounts. |
| Keywords | Account, Acct, Acct #, Acct No |

Attributes

| | | | |
|---|---|---|---|
| | | Relevancy | |
| | | (on a scale of | |
| | | 1-10, 10 | |
| | | being most | |
| | | relevant; | |
| Attribute Name | Description | default is 7) | Comments |

Control Fields

| | | | |
|---|---|---|---|
| Last Update Date | The time that the | n/a | Change in this attribute triggers search engine to update the index |
| | customer account record | | |
| | was last updated | | |

Security Attributes

| | | | |
|---|---|---|---|
| Resource | Sales team resource | n/a | Adjust security as resource is added or removed from the customer |
| | | | account team. |
| Resource Org | Org team | n/a | Adjust security as resource org association is added or removed |
| | | | from the customer account. |
| Territory | Territory team | n/a | Adjust security as territory association is added or removed from |
| | | | the customer account. |

Display Attributes (Fixed Content)
Note: Account number will already be shown in main link title

| | | |
|---|---|---|
| Primary Contact | Account primary contact | n/a |
| | name | |

Searchable Attributes (Variable Content)
Note: Attribute in bold style are filter attributes for Advanced Search

| | | | |
|---|---|---|---|
| Account Number | Account number | 10 | Most relevant |
| Customer Name | Customer name | 7 | |
| Account Description | Description chosen by | 7 | |
| | external party (but can | | |
| | be entered internally on | | |
| | behalf of the customer) | | |
| Account Comments | Free format info about | 7 | |
| | the Account | | |
| Customer Class Code | Customer class | 7 | |
| | identifier. For example, | | |
| | an account created for a | | |
| | reseller or educational | | |
| | customers would have a | | |
| | customer_class_code as | | |
| | reseller or education. | | |
| Account Contacts | Comma separated list of | 9 | |
| | account contact names | | |
| Account Contact Role | Account contact role | 7 | |
| Type | type | | |
| Account Address | Account site address | 8 | |

Additional Filter Attributes
Note: Searchable Attributes in bold style above are also filter attributes for Advanced Search

| | | | |
|---|---|---|---|
| Customer Type | Internal Customer or | 7 | This is a filter attribute only, not a search attribute |
| | Revenue-generating | | |
| | External Customer | | |

Search Results Layout

| | |
|---|---|
| Main Link Title | Billing Account: [Account number] |
| | Eg: Billing Account: 123 |
| Main Link Target | Customer 360 on Billing Accounts node |
| Main Link Hover Text | None |
| Actions (Optional) | None |

One advantage of the logical grouping illustrated by FIG. 3 is that the grouping lends itself to a variety of searches. Customer-specific searches can be performed in each customer object (e.g., 320(1)). Alternatively, a search can be performed across customers by addressing the search to the entire logical group 310.

Contextual Search

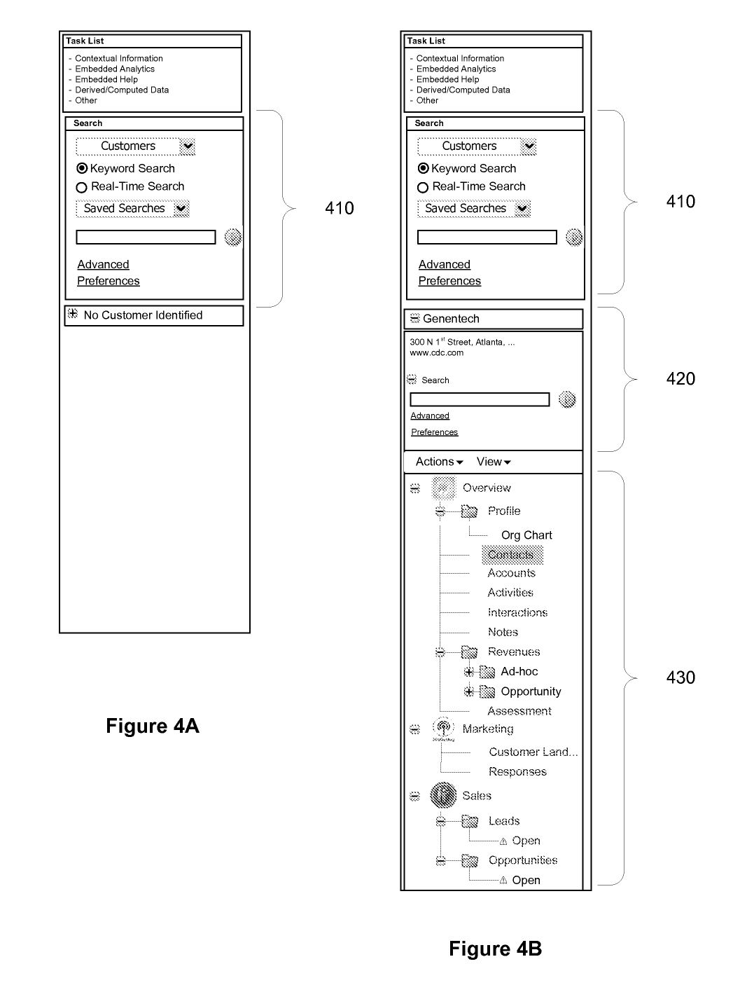

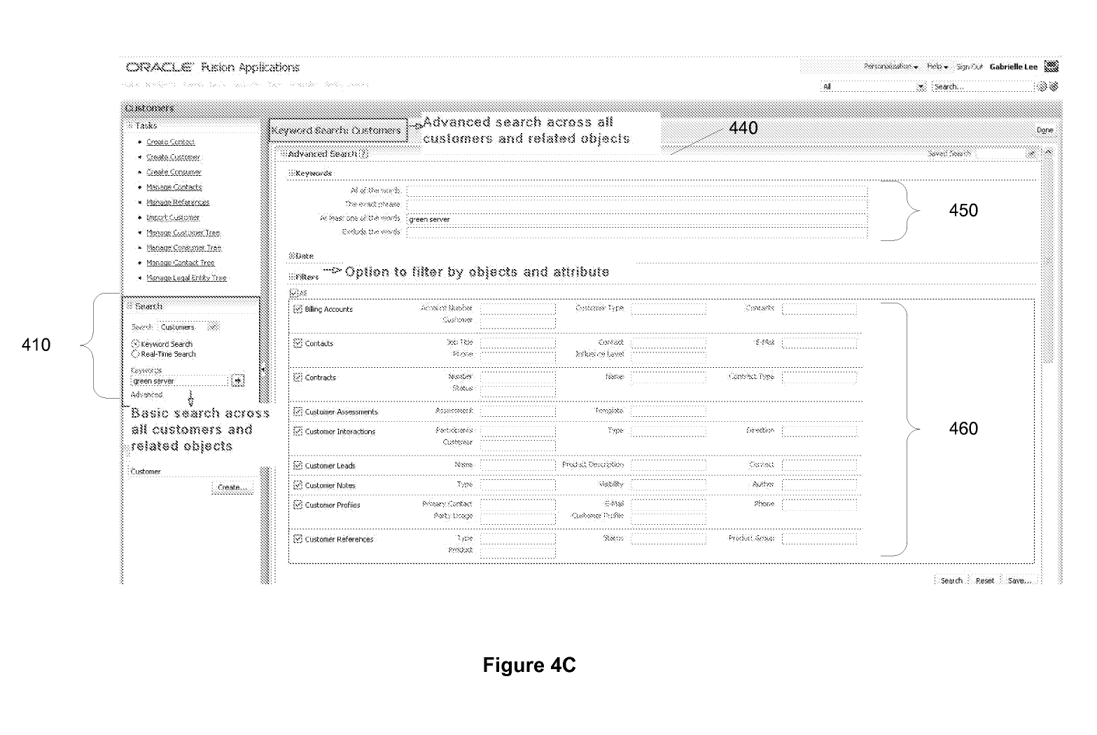

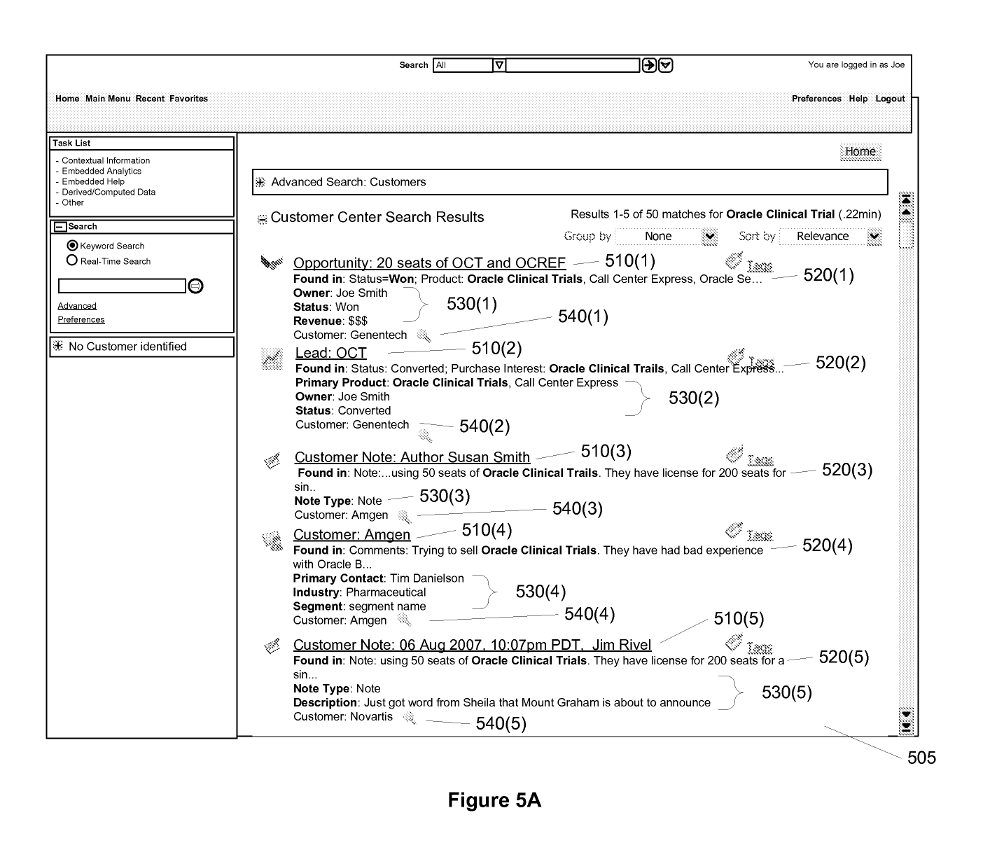

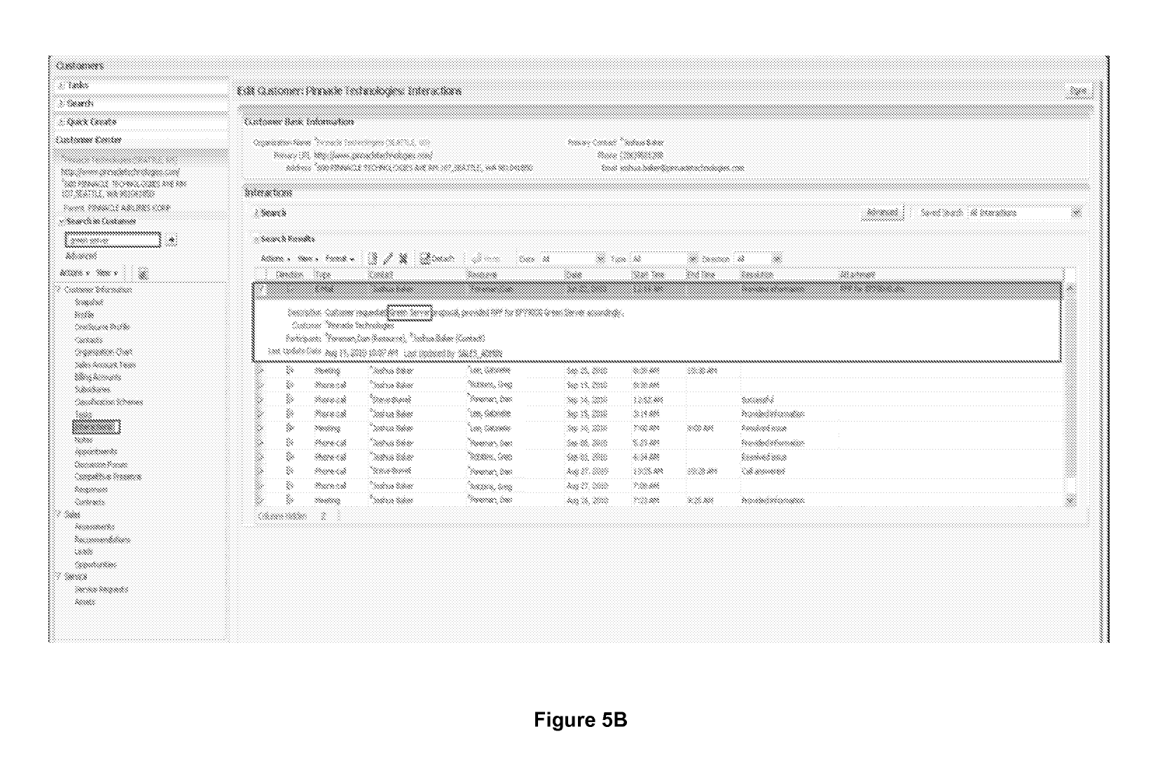

FIG. 4A illustrates an example of a search interface provided by embodiments of the present invention. Element 410 of the interface allows for entry of one or more search keywords that can then be applied against records related to all customer identifiers in the available search indexes. As illustrated, keywords are entered in the box and subsequently applied against search index entries for the Customers search group. Results of such a search are discussed below with regard to FIG. 5.

FIG. 4B illustrates a customer-focused search interface usable by embodiments of the present invention. Element 410 of FIG. 4B corresponds to element 410 of FIG. 4A; that is, an interface allowing for a keyword search across all customers, including customer-related objects. Element 420 provides information about a specific enterprise customer as found in the enterprise's customer data sources. Element 420 information can be a result of a prior search performed, or selection of a customer from a list of available customers in another displayed view pane. The box in element 420 allows for entry of one or more keywords that can then be searched across all searchable objects associated with the displayed customer. In addition, element 430 shows a listing of related objects which are also available searchable objects for the customer displayed in element 420. Through the list in element 430, a user can select a specific object to view all data records for that object and drill down to each data record. A Customer search result not only takes user to the specific customer (element 420), it further takes user to the specific object for that customer (element 430) and highlights the exact data record which contains the keywords. Using the hub-and-spoke analogy above, each search result navigates to the relevant spoke where the record is found in a given customer context.

FIG. 4C illustrates an example of an advanced search display usable by embodiments of the present invention. As seen in FIGS. 4A and 4B, elements 410 and 420 include a link to “advanced search” and a link to “search preferences.” FIG. 4C illustrates an example of a display available to setting the advanced search. As illustrated, an advanced search pane 440 enables inclusion of keywords in a number of fashions (e.g., inclusion, exclusion, and phrases) (450). In addition, advanced search pane 440 also includes various filter fields 460 that are defined in accord with the searchable object (e.g., a spoke) and allow for inclusion or exclusion of objects to the search. As shown in element 460, each searchable object has a defined set of attributes that can be used to filter a search. For example, filter attributes for billing accounts include account number, customer type, contacts, and customer. Filter attributes can also include business intelligence metrics such as number of open opportunities or number of open service requests. A specified keyword can be provided in any attribute field in order to perform desired filtering.

Search preferences allow users to customize the default list of search objects and other options such as whether to enable dynamic search suggestions. For example, a sales agent may search across leads, opportunities, and service requests by default. On the other hand, a support representative may focus on searching accounts and service requests by default. A search preferences user interface can be provided that allows a user to check off those search objects within which they preferentially wish to search. Options can include for example, in the case of a customer relationship management application, objects such as accounts, assessments, contacts, customers, customer notes, customer teams, interactions, leads, opportunities, product landscape, references, responses, revenues, tasks, and the like.

Additionally, one embodiment of the search interface is configured to provide dynamic search suggestions. That is, as a user types in search keywords, the interface suggests matches to the keywords based on, for example, customer name, contact name, and opportunity name. The provided suggestions can be based on primary identifiers for customer and related objects.

As can be seen in FIG. 4C, not only is advanced search pane 440 displayed but also a basic search pane 410 is made available. It should also be noted that as illustrated, advanced search pane 440 performs a search across all customers, but a similar advanced search pane can be made available for a customer-specific search.

The advanced search pane allows for tailoring of a search to a user's needs. Not only can a user select those “spokes” upon which a search is desired, but also a user can select very specific information within each data source upon which to conduct a search.

FIG. 5A illustrates an example of a search results pane provided by a search across customers for a set of keywords, as provided by embodiments of the present invention. As illustrated, a search has been performed across all customers for the phrase “Oracle clinical trial.” Five results of the search are illustrated in results pane 505. These results are representative of data in the search index. Each result has a main link 510 that can provide direct access to the source record associated with the displayed result. For each result, main link 510 includes an identifier of the associated data source (e.g., opportunity, lead, customer note, and customer) and an identifier of the associated record (e.g., “20 seats of OCT and OCREF”). Each displayed result also includes a snippet of the content in the index record that contains the found keywords (520). The length of snippet 520 is set to a sufficient length for a user to be able to determine relevance of the associated record.

Each displayed record also includes a fixed list of attributes which identify the result record (530). Different result types have different fixed attributes. For example, an opportunity record type includes fixed attributes 530(1): owner, sales stage, and revenue. By contrast, a customer record includes a set of fixed attributes 530(4): primary contact, industry, and address.

Finally, each displayed result includes a customer name associated with the result (540). Since customer context is the focus of these searches, this format ensures that a user can quickly spot a customer context for each result. If the associated search had been for a specific customer rather than over all the customers, then the result list would not include a customer identifier for each record since the associated customer is known.

The information provided in search results pane 505 is drawn from records in the search index. If a user is interested in a particular record provided in the search results list, the user can click on the hyperlink result title 510. The information associated with the indexed record from the relevant data source will then be displayed in context of the customer and customer-related objects (e.g., the opportunity data source for result 510(1)). Embodiments of the present invention can also provide an ability for a user to view additional customer-related information once a search object has been selected. That is, if the user determines that the information related to the customer associated with a particular opportunity is of interest, the user can then use hyperlinks to view customer profile information and perform additional searches upon that specific customer in a customer-specific context.

FIG. 5B illustrates an example of a “drill down” display for an object listed in a search result, in accord with one embodiment of the present invention. FIG. 5B shows the drill down from a search result which is a customer interactions object containing keywords “green server.”

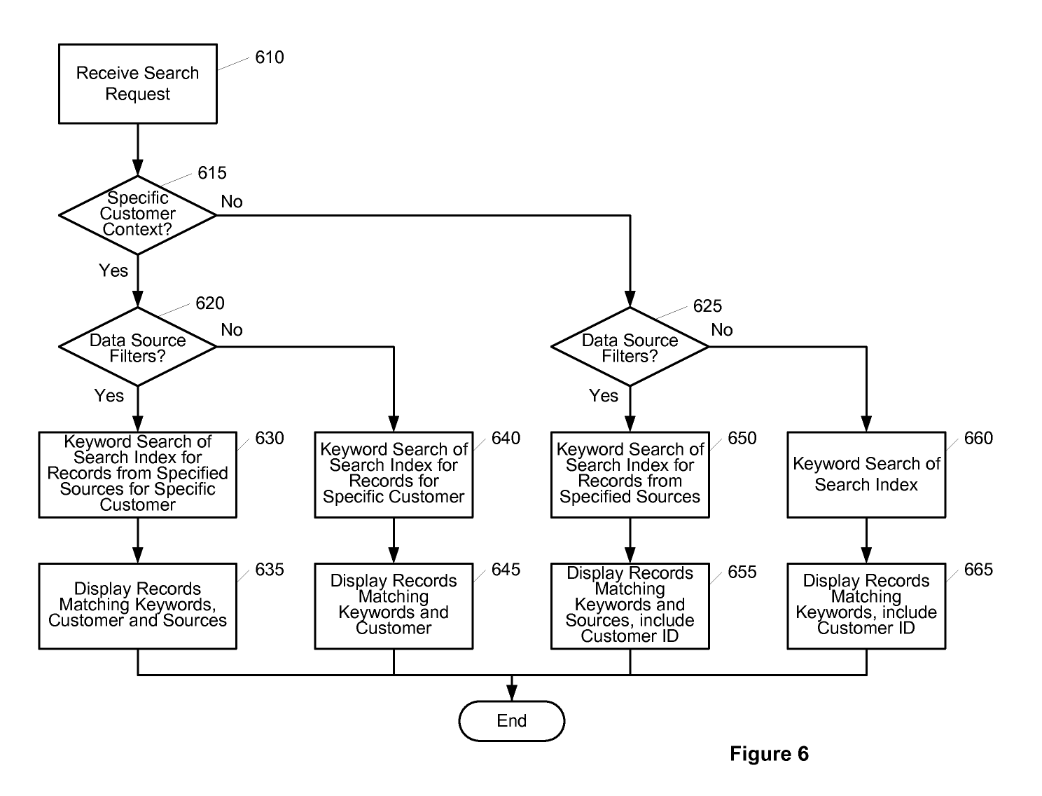

FIG. 6 is a simplified flow diagram illustrating an example of a search procedure executed by embodiments of the present invention. The search process begins with a search request being received (610). As illustrated, such a search request can be provided by entry of a keyword in element 410, element 420, or element 440 of FIGS. 4A, 4B, and 4C, respectively. The search request can include a keyword and filtering options. Once the search request is received, a determination is made as to whether the search is in a specific customer context (615). As previously discussed, embodiments of the present invention can provide for searches performed across all customers of the enterprise or a search across all the information related to a specific customer. In each case, the next determination is whether or not data source filters are being applied in the search (620 and 625). Such data source filters can include selection of the “spokes” applicable to the customer search and additional attribute filtering, as displayed and discussed with regard to FIG. 4C.

If the search is within a specific customer context and data source filters are being applied, then a keyword search is performed of the relevant search indexes for records from the specified data sources for the specified customer (630). Records for a specific customer are associated with a customer identifier for that customer. That customer identifier can be a primary key for information from customer profiles and a foreign key for other data records. In addition, if data does not include the enterprise's customer identifiers, a mapping can be made of the foreign data's customer identifiers to the enterprise's customer identifiers in order to properly associate those records. Once responsive records have been found, those records having matching keywords, customer identifier and filtered sources can be displayed in a manner similar to that illustrated in FIG. 5 (635). Since these results are for a specific customer, there will be no customer identifier associated with each result, but these results will be displayed in a context associated with the specific customer identified.

If the search is for information related to a specific customer, but with no applied data source filters, then a search of the relevant search indexes for records for the specified customer is performed (640). Again, the relevant records are associated with the particular customer identifier associated with the specified customer and include fields having the stated keywords. Those found records are displayed in a manner similar to that illustrated in FIG. 5 (645).

If the search is across all customer in the enterprise and there are to be data source filters applied, then a keyword search of the relevant search indexes is performed for records matching the stated filter criteria (e.g., a specified spoke) and having the stated keywords in an element of the record (650). Those matching records are then displayed and include a customer identifier with each of the displayed results (655).

Finally, if there is no specific customer context and there are no data source filters applied, then a keyword search is performed of the relevant search indexes (660). The results display then includes all records having matching keywords and are displayed with an associated customer identifier (665).

As the scope of the stated searches increases (e.g., fewer filters and more than one customer), the results list can include increasing numbers of records. In order to provide a user with the most useful information early in a results list, relevance criteria can be defined and associated with attributes in the searchable view objects. As can be seen in Table 1, each attribute can include a relevancy weighting on a scale of 1-10, where 10 is the most relevant. These relevance ratings are defined in light of the importance of the attribute to the particular searchable view object. For example, for a customer account object, the account number is the most relevant field. Thus, if a keyword equaling the account number finds a match in the account description field, that record will be displayed early in the results list. If, however, a matching number is found in account comments (for example), which has a relevancy rating of 7, such a record will be lower in the results list. When generating the results list, relevancy ratings for all of the found matching objects are reviewed and the list is organized in an appropriate fashion according to those weighted results.

Careful consideration is given to define the relevance ranking of search results based on attribute weighting. Primary identifying attributes are weighted higher than non-primary attributes. For example, a Contact object's primary attributes (e.g., Contact Name, E-mail and Address) are weighted higher than non-primary attributes such as Comments or Role/Responsibility. Given the related nature of context-associated objects, attribute weighting is further normalized across objects for common attributes such as Customer Name, Contact Name and Product Name. For example, Contact Name is an attribute for the Contact object. Contact Name can also be the Primary Contact attribute for a Customer or Opportunity object, or a Participant attribute in an Interaction object. In this scenario, a match in Contact Name is ranked as the most relevant, a match in Customer and Opportunity primary contact as the second most relevant, and a match in Interaction participant as the third most relevant.

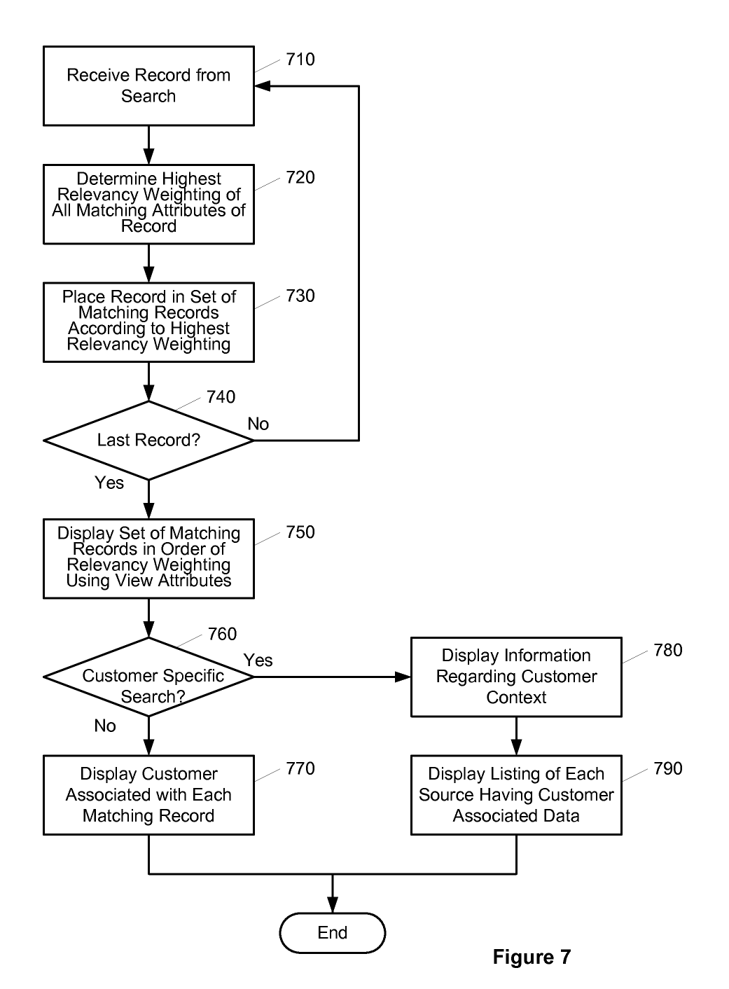

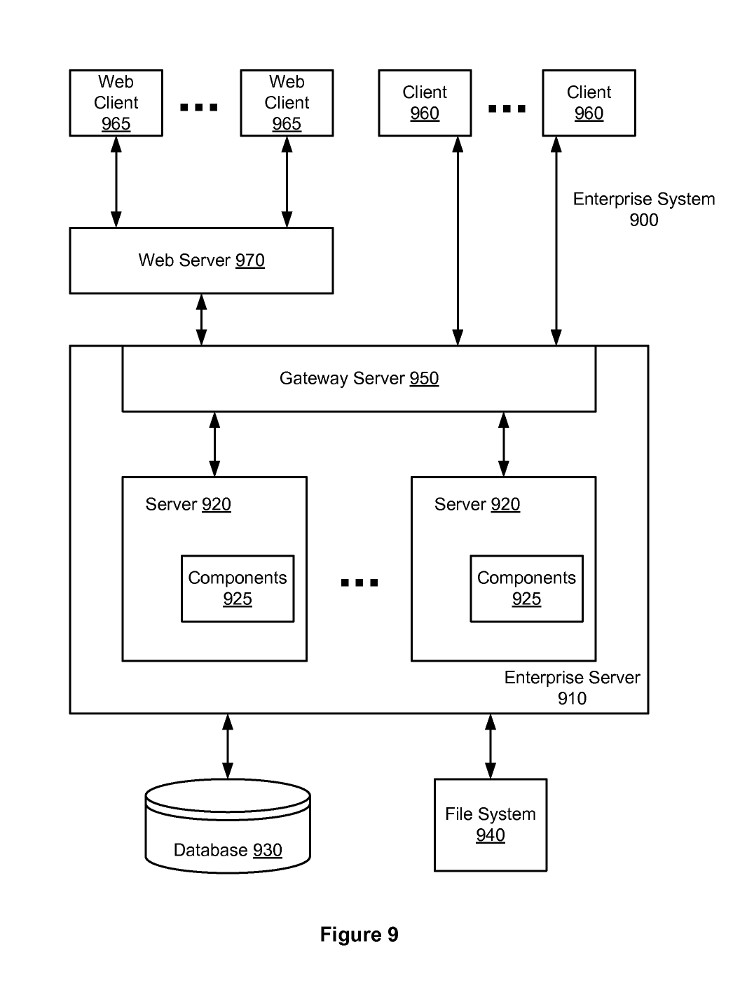

FIG. 7 is a simplified flow diagram illustrating a process for displaying records matching keywords from a search, in accord with embodiments of the present invention. This process can be used to perform the displaying actions of elements 635, 645, 655, and 665 of FIG. 6, for example. Elements of this process can be performed by, for example, a server that generates the search result display discussed above (e.g., FIG. 9).

The display process begins by receiving a record matching the search parameters (e.g., keywords and applied filters) from a search index search (710). Attributes of the received record are examined to determine a highest relevancy weighting of all attributes containing the search keywords (720). In accord with this highest relevancy weighting, the record can be placed in an appropriate ordered location in a set of other matching records (730). An alternative criteria for ordered placing of the received record can be to aggregate the weighting of all record attributes having the keywords and using the aggregate weighting to place the record in the set. These steps are performed for each record received as a result of the search (740).

Once all records have been received and organized, a display image can be generated of the relevancy ordered set of matching records (750). The displayed fields of the matching records are determined using the view attributes of the source record type, as discussed above. If the search was not a customer-specific search (760), then a customer identifier associated with each found record is also displayed with each found record (770). If the originating search is performed in a customer context, then the display generated can generally include information related to the customer context of the search (780). In addition, a listing of each data source having customer-associated data can also be generated for display (790).

In generating the display of the set of matching records, each displayed record can include a link to corresponding source data of that matching record. Information used to generate that link is found in the search index record, which includes a pointer to the source data. Through the use of such search results, records within a wide variety of data sources can be evaluated within the customer context quickly due to a single viewing environment.

Example Enterprise Data Environment

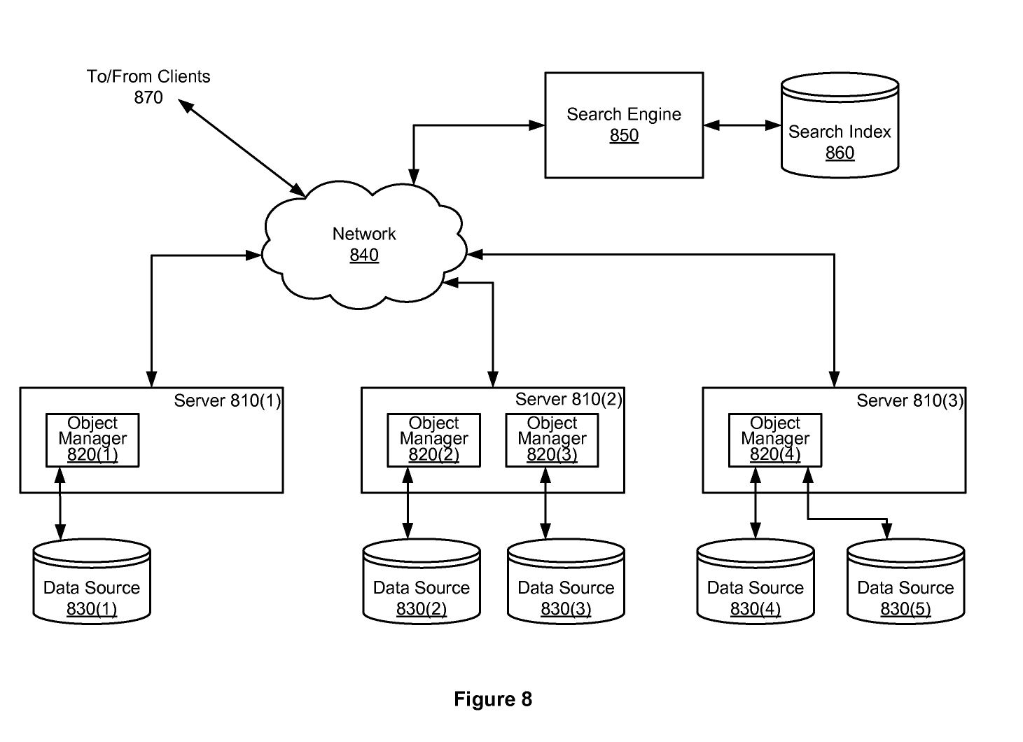

FIG. 8 is a simplified block diagram illustrating one example of an enterprise data environment compatible with embodiments of the present invention. Servers 810 can each support one or more object manager process 820. An object manager can include business logic for a desired task, along with mechanisms to access different data sources 830. An object manager process 820 can receive requests to create, modify, or search for records in a corresponding data source 830 from clients of that object manager (e.g., clients 870). As illustrated, a server 810 can support one object manager process 820 (e.g., server 810(1) supporting object manager 820(1)) or multiple object manager processes (e.g., server 810(2) supporting object manager processes 820(2) and 820(3)). Likewise, an object manager process can interact with a single data source (e.g., object manager process 820(1) interacting with data source 830(1)) or multiple data sources (e.g., object manager process 820(4) interacting with data sources 830(4) and 830(5)).

As illustrated, the servers are coupled via a network 840 to a search engine 850. Network 840 can be a local area network, metro area network, or wide area network, and can support a variety of protocols. Embodiments of the present invention are not limited by the nature of network 840 or the protocol supported thereon. Search engine 850 includes records in one or more search indexes 860 corresponding to data found in data sources 830. An initial build of search index 860 can be performed by “crawling” processes that examine and report data records from data sources 830 to search engine 850 for inclusion in search index 860. As new records are added to data sources 830, object managers 820 can report the new information to search index 850 for inclusion in search index 860.

One or more clients 870 can access data stored in either data sources 830 or search index 860 by accessing object manager processes 820, or by presenting a search request in association with the object manager processes or a separate object manager process.

As the search engine gathers data from the various data sources 830, each record generated for the search index should include an appropriate contextual identifier for that information. For example, as discussed above, in a CRM environment, a natural contextual identifier is a unique customer identifier. For those data sources having a foreign contextual identifier, either the search engine or a contextual search object manager of the present invention can perform a mapping between the foreign contextual identifiers and corresponding contextual identifiers of the other data sources.

An Example Enterprise Server Architecture

FIG. 9 is a simplified block diagram illustrating an enterprise server architecture usable in conjunction with embodiments of the present invention. The illustrated enterprise server architecture includes an enterprise server 910 that is a logical grouping of one or more servers 920 that support a group of clients (960, 965) accessing a common database 930. An enterprise server can be configured, managed and monitored as a single logical group, allowing an administrator to start, stop, monitor or set parameters for servers 920 within enterprise server 910. In such a configuration, parameters for the enterprise system can be set at the enterprise server level, and these parameters can apply to every server operating within the enterprise server. In addition, other parameters can be adjusted at a server (920) level to support fine tuning of those parameters. In this hierarchical parameter context, if a parameter is set at a server level, then the server-specific value for the parameter can override an enterprise server-level setting for the parameter. Further, parameter setting at a component level (process executed on servers 920) will override those set at the server level.

Servers 920 can support back-end and interactive processes for each client accessing the server. These processes are illustrated as one or more components 925 within each server. A server 920 can support, for example, multiprocess and multithreaded components, and can operate components in background, batch, and interactive modes. A server component can also operate on multiple servers 920 simultaneously to support an increased number of users or larger batched workloads. Examples of component processes include, for example, mobile web client synchronization, operation of business logic for web clients, connectivity and access to database and file systems for clients, integration with legacy or third-party data (e.g., data not native to the enterprise system), automatic assignment of new accounts, opportunities, service requests, and other records, and work flow management. Embodiments of the search processes of the present invention can also be implemented to execute on one or more of servers 920 as components.

Servers 920 are coupled to a gateway server 950, illustrated as part of enterprise server 910. Gateway server 950 can coordinate the operations of enterprise server 910 and servers 920. A gateway server can provide persistent storage of enterprise server configuration information, including, for example, definitions and assignments of component groups and components, operational parameters, and connectivity information. A gateway server can also serve as a registry for server and component availability information. For example, a server 920 within enterprise server 910 can notify gateway server 950 of availability. Connectivity information such as network addresses can be stored in a storage accessed by gateway server 950. If a server 920 shuts down or otherwise becomes unavailable, connectivity information related to that server can be cleared from gateway server 950.

Through their relationship in enterprise server 910, servers 920 and their components 925 can access one or more data sources (e.g., databases 930 and file systems 940). Database 930 can store, for example, RDBMS client software and tables, indexes, and data related to all operations impacted by the enterprise system. Database information can include, for example, customer information, market data, historical pricing information, current pricing information, contact information, and the like. Similarly, file system 940 can store data and physical files used by clients 960 and 965 and enterprise server 910. File system 940 can be a shared directory, or set of directories on different devices, which is network-accessible to all servers 920 in enterprise server 910. In order for a client to gain access to files in file system 940, a client can connect to an appropriate server 920 to request file uploads or downloads. Server 920 can then access file system 940 using, for example, a file system management component.

As stated above, embodiments of these search processes of the present invention can be implemented to execute as components on one or more of servers 920, accessing database 930 to store and retrieve data. An alternative embodiment provides a separate server accessible by the same or different web server.

Clients 960 and 965 provide access to enterprise server 910 for agents using the enterprise system. Clients communicate to enterprise server 910 through gateway server 950 either directly (e.g., client 960) or via a web server 970 (e.g., clients 965). A web server 970 can provide a mechanism by which enterprise server 910 can respond to web-based requests (e.g., HTML, XML, and the like). Web clients 965 can include clients coupled to web server 970 via a local area network, metro area network, or wide area network and propagated over a variety of communications media, as discusses above. Further, web clients 965 can include mobile clients accessing web server 970 through wireless communications means. Users of clients 960 and web clients 965 can include, for example, sales agents, service agents, customer representatives, managers of the business entity using a CRM, and the like. Users have access to all information accessible to enterprise server 910 in database 930, as controlled by a user's secured access rights.

Clients 960 and web clients 965 can be distributed throughout an enterprise and can include hundreds or thousands of such clients. Each client can perform tasks related to either creating new records to be stored in, for example, database 930, modifying records in database 930, or searching for information stored in database 930.

An Example Computing and Network Environment

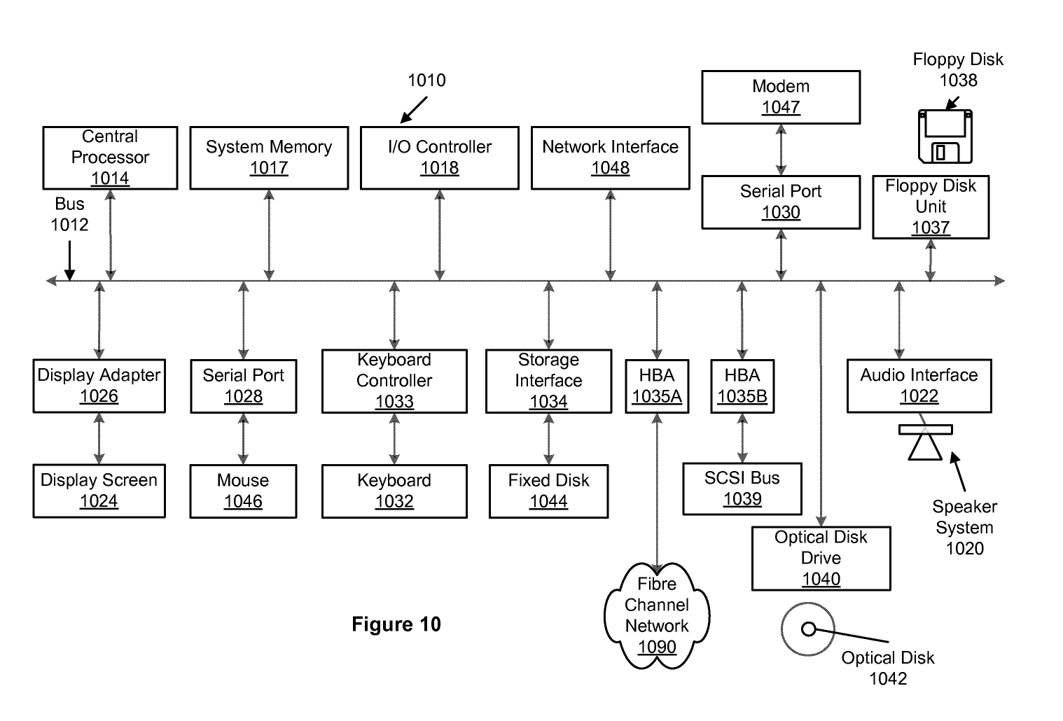

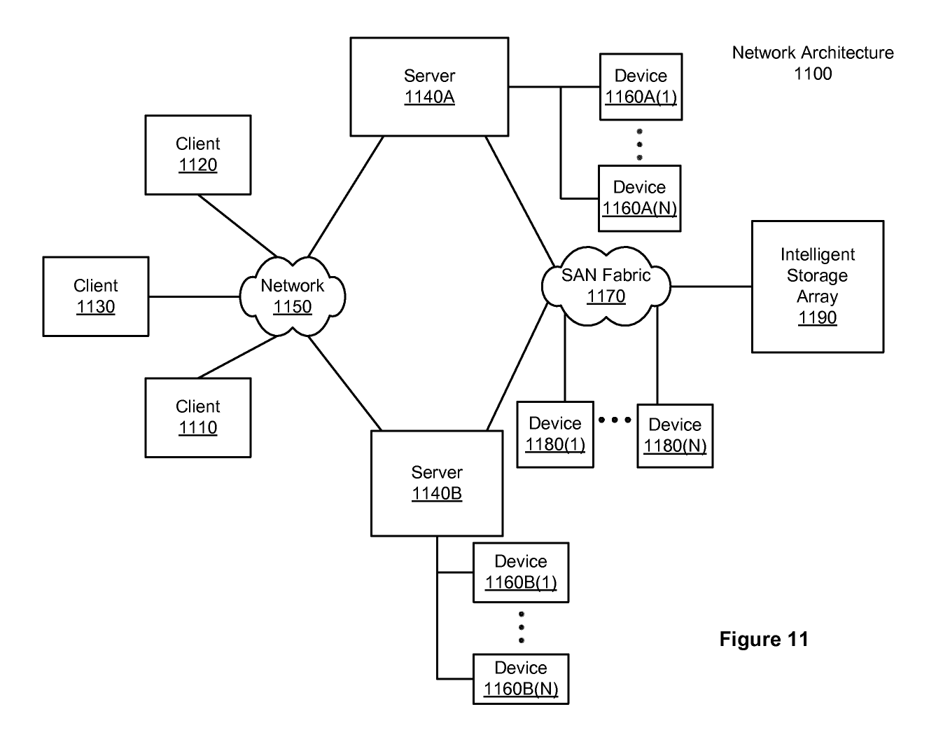

As shown above, the present invention can be implemented using a variety of computer systems and networks. An example of one such computing and network environment is described below with reference to FIGS. 10 and 11.

FIG. 10 depicts a block diagram of a computer system 1010 suitable for implementing aspects of the present invention (e.g., servers 920, gateway server 950, clients 960 and web clients 965). Computer system 1010 includes a bus 1012 which interconnects major subsystems of computer system 1010, such as a central processor 1014, a system memory 1017 (typically RAM, but which may also include ROM, flash RAM, or the like), an input/output controller 1018, an external audio device, such as a speaker system 1020 via an audio output interface 1022, an external device, such as a display screen 1024 via display adapter 1026, serial ports 1028 and 1030, a keyboard 1032 (interfaced with a keyboard controller 1033), a storage interface 1034, a floppy disk drive 1037 operative to receive a floppy disk 1038, a host bus adapter (HBA) interface card 1035A operative to connect with a Fibre Channel network 1090, a host bus adapter (HBA) interface card 1035B operative to connect to a SCSI bus 1039, and an optical disk drive 1040 operative to receive an optical disk 1042. Also included are a mouse 1046 (or other point-and-click device, coupled to bus 1012 via serial port 1028), a modem 1047 (coupled to bus 1012 via serial port 1030), and a network interface 1048 (coupled directly to bus 1012).

Bus 1012 allows data communication between central processor 1014 and system memory 1017, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with computer system 1010 are generally stored on and accessed via a computer-readable medium, such as a hard disk drive (e.g., fixed disk 1044), an optical drive (e.g., optical drive 1040), a floppy disk unit 1037, or other storage medium. Additionally, applications can be in the form of electronic signals modulated in accordance with the application and data communication technology when accessed via network modem 1047 or interface 1048.

Storage interface 1034, as with the other storage interfaces of computer system 510, can connect to a standard computer-readable medium for storage and/or retrieval of information, such as a fixed disk drive 1044. Fixed disk drive 1044 may be a part of computer system 1010 or may be separate and accessed through other interface systems. Modem 1047 may provide a direct connection to a remote server via a telephone link or to the Internet via an internet service provider (ISP). Network interface 1048 may provide a direct connection to a remote server via a direct network link to the Internet via a POP (point of presence). Network interface 1048 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 10 need not be present to practice the present invention. The devices and subsystems can be interconnected in different ways from that shown in FIG. 10. The operation of a computer system such as that shown in FIG. 10 is readily known in the art and is not discussed in detail in this application. Code to implement the present invention can be stored in computer-readable storage media such as one or more of system memory 1017, fixed disk 1044, optical disk 1042, or floppy disk 1038. The operating system provided on computer system 1010 may be MS-DOS®, MS-WINDOWS®, OS/2®, UNIX®, Linux®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present invention may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

FIG. 11 is a block diagram depicting a network architecture 1100 in which client systems 1110, 1120 and 1130, as well as storage servers 1140A and 1140B (any of which can be implemented using computer system 1010), are coupled to a network 1150. Storage server 1140A is further depicted as having storage devices 1160A(1)-(N) directly attached, and storage server 1140B is depicted with storage devices 1160B(1)-(N) directly attached. Storage servers 1140A and 1140B are also connected to a SAN fabric 1170, although connection to a storage area network is not required for operation of the invention. SAN fabric 1170 supports access to storage devices 1180(1)-(N) by storage servers 1140A and 1140B, and so by client systems 1110, 1120 and 1130 via network 1150. Intelligent storage array 1190 is also shown as an example of a specific storage device accessible via SAN fabric 1170.

With reference to computer system 1010, modem 1047, network interface 1048 or some other method can be used to provide connectivity from each of client computer systems 1110, 1120 and 1130 to network 1150. Client systems 1110, 1120 and 1130 are able to access information on storage server 1140A or 1140B using, for example, a web browser or other client software (not shown). Such a client allows client systems 1110, 1120 and 1130 to access data hosted by storage server 1140A or 1140B or one of storage devices 1160A(1)-(N), 1160B(1)-(N), 1180(1)-(N) or intelligent storage array 1190. FIG. 11 depicts the use of a network such as the Internet for exchanging data, but the present invention is not limited to the Internet or any particular network-based environment.

### Other Embodiments

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

The foregoing describes embodiments including components contained within other components (e.g., the various elements shown as components of computer system 1010). Such architectures are merely examples, and, in fact, many other architectures can be implemented which achieve the same functionality. In an abstract but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality.

The foregoing detailed description has set forth various embodiments of the present invention via the use of block diagrams, flowcharts, and examples. It will be understood by those within the art that each block diagram component, flowchart step, operation and/or component illustrated by the use of examples can be implemented, individually and/or collectively, by a wide range of hardware, software, firmware, or any combination thereof, including the specialized system illustrated in FIG. 9.

The present invention has been described in the context of fully functional computer systems; however, those skilled in the art will appreciate that the present invention is capable of being distributed as a program product in a variety of forms, and that the present invention applies equally regardless of the particular type of computer-readable media used to actually carry out the distribution. Examples of computer-readable media include computer-readable storage media, as well as media storage and distribution systems developed in the future.

The above-discussed embodiments can be implemented by software modules that perform one or more tasks associated with the embodiments. The software modules discussed herein may include script, batch, or other executable files. The software modules may be stored on a machine-readable or computer-readable storage media such as magnetic floppy disks, hard disks, semiconductor memory (e.g., RAM, ROM, and flash-type media), optical discs (e.g., CD-ROMs, CD-Rs, and DVDs), or other types of memory modules. A storage device used for storing firmware or hardware modules in accordance with an embodiment of the invention can also include a semiconductor-based memory, which may be permanently, removably or remotely coupled to a microprocessor/memory system. Thus, the modules can be stored within a computer system memory to configure the computer system to perform the functions of the module. Other new and various types of computer-readable storage media may be used to store the modules discussed herein.

The above description is intended to be illustrative of the invention and should not be taken to be limiting. Other embodiments within the scope of the present invention are possible. Those skilled in the art will readily implement the steps necessary to provide the structures and the methods disclosed herein, and will understand that the process parameters and sequence of steps are given by way of example only and can be varied to achieve the desired structure as well as modifications that are within the scope of the invention. Variations and modifications of the embodiments disclosed herein can be made based on the description set forth herein, without departing from the scope of the invention.

Consequently, the invention is intended to be limited only by the scope of the appended claims, giving full cognizance to equivalents in all respects.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A method comprising:
searching through a set of records associated with one or more enterprise data sources for records containing one or more selected words, wherein each record of the set of records has an associated contextual identifier; and
displaying at least a portion of each record containing the one or more selected words and the contextual identifier associated with each record containing the one or more selected words.

2. The method of claim 1 further comprising:
limiting the set of records to those records associated with a specified contextual identifier; and
displaying information associated with the specified contextual identifier.

3. The method of claim 2 further comprising:
displaying a listing of the data sources associated with the records containing the one or more selected words, wherein the listing of data sources is a subset of the one or more enterprise data sources.

4. The method of claim 3 further comprising:
selecting a data source from the listing of data sources associated with the records containing the one or more selected words; and
limiting said displaying of the set of records associated with the specified contextual identifier to those records associated with the selected data source.

5. The method of claim 1 wherein said portion of each record comprises:
an identifier of the enterprise data source associated with the record;
an identifier of the record; and
a portion of the record comprising the one or more selected words and a predetermined number of additional words immediately preceding and succeeding the one or more selected words.

6. The method of claim 5 wherein said displaying at least a portion of each record further comprises:
displaying a link to the location in the enterprise data source identified by the displayed portion of the record.

7. The method of claim 1 further comprising:
generating a search index comprising the set of records associated with the one or more enterprise data sources; and
performing said searching using the search index.

8. The method of claim 7 wherein said generating the search index further comprises:
storing a record in the search index comprising information from the enterprise data source for the record, a pointer to the location of original data for the record in the enterprise data source, and the associated contextual identifier.

9. A computing system comprising:
a first storage volume storing a search index, the search index comprising records associated with one or more enterprise data sources and each record comprises an associated contextual identifier; and
a processor, coupled to the first storage volume and a display, and configured to receive one or more selected words,
search through the records for records containing the one or more selected words, and
display at least a portion of each record containing the one or more words and the contextual identifier associated with each record containing the one or more selected words.

10. The computing system of claim 9 wherein the processor is further configured to:
limit the records searched to those records associated with a specified contextual identifier; and
display information associated with the specified contextual identifier.

11. The computing system of claim 10 wherein the processor is further configured to:
display a listing of the data sources associated with the records containing the one or more selected words, wherein the listing of data sources is a subset of the one or more enterprise data sources.

12. The computing system of claim 11 wherein the processor is further configured to:
select a data source from the listing of data sources associated with the records containing the one or more selected words; and
limit said displaying of the set of records associated with the specified contextual identifier to those records associated with the selected data source.

13. The computing system of claim 9 wherein said portion of each record comprises:
an identifier of the enterprise data source associated with the record;
an identifier of the record; and
a portion of the record comprising the one or more selected words and a predetermined number of additional words immediately preceding and succeeding the one or more selected words.

14. The computing system of claim 13 wherein the processor is configured to display at least a portion of each record by being further configured to:
display a link to the location in the enterprise data source identified by the displayed portion of the record.

15. The computing system of claim 9 wherein the processor is further configured to:
generate a search index comprising the set of records associated with the one or more enterprise data sources; and
perform said searching using the search index.

16. The computing system of claim 15 wherein the processor is configured to generate the search index by being further configured to:
store a record in the search index comprising information from the enterprise data source for the record, a pointer to the location of original data for the record in the enterprise data source, and the associated contextual identifier.

17. A computer-readable storage medium, storing instructions executable by a processor, said instructions comprising:
a first set of instructions configured to search through a set of records associated with one or more enterprise data sources for records containing one or more selected words, wherein each record of the set of records has an associated contextual identifier; and
a second set of instructions configured to display at least a portion of each record containing the one or more selected words and the contextual identifier associated with each record containing the one or more selected words.

18. The computer-readable storage medium of claim 17 wherein the instructions further comprise:
a third set of instructions configured to limit the set of records to those records associated with a specified contextual identifier; and
a fourth set of instructions configured to display information associated with the specified contextual identifier.

19. The computer-readable storage medium of claim 18 wherein the instructions further comprise:
a fifth set of instructions configured to display a listing of the data sources associated with the records containing the one or more selected words, wherein the listing of data sources is a subset of the one or more enterprise data sources.

20. The computer-readable storage medium of claim 19 wherein the instructions further comprise:
a sixth set of instructions configured to select a data source from the listing of data sources associated with the records containing the one or more selected words; and
a seventh set of instructions configured to limit said displaying of the set of records associated with the specified contextual identifier to those records associated with the selected data source.
